(19) United States
(12) Patent Application Publication
(10) Pub. No.: US 2009/0127053 A1
(43) Pub. Date: May 21, 2009

(54) Coupling assembly including retainers for holding coupling components within a housing

(76) Inventors: Brian M. Nosakowski, Macomb, MI (US); Terry O. Hendrick, Cass City, MI (US); Jeffrey C. Hoppe, Cass City, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/986,246

(22) Filed: Nov. 20, 2007

(51) Int. Cl. F16D 13/52

(52) U.S. Cl. 192/70.2

(57) ABSTRACT

A coupling assembly including an annular housing, an inner member and a plurality of coupling components is provided. The coupling components include a coupling pack, an actuator and springs between the actuator and the inner member. A set of retainers in the form of retaining tabs hold the coupling components as well as the inner member within the housing.

### CROSS-REFERENCE TO RELATED APPLICATIONS

This application is related to the following commonly owned U.S. patent application filed on the same date as this application: “Coupling Assembly Including One or More Springs Received Within A Coupling Pack” (Attorney Docket No. MEII 0259 PUS).

### BACKGROUND OF THE INVENTION

1. Field of the Invention

This invention relates to coupling assemblies which can be utilized as a clutch or brake, etc. and, in particular, to such coupling assemblies including retainers for holding coupling components within a housing.

2. Background Art

Mechanically applied coupling assemblies that can be used as a clutch or brake are disclosed by U.S. Pat. No. 4,630,720 Boni and U.S. Pat. No. 6,332,514 Chen. Such coupling assemblies have previously included a clutch pack of alternating discs coupled to an outer housing and an inner member such that compression of the clutch pack provides rotational coupling between the housing and the inner member. The compression of the clutch pack has previously been performed with a ring of frustoconical-shaped actuating levers. Such actuating levers should be accurately positioned with respect to each other and the housing in order to provide effective operation of the coupling.

FIG. 1 is a view of a prior art coupling assembly, generally indicated at 10. The assembly 10 includes an annular drum or housing 12 having a central axis 14. The assembly 10 also includes a sprocket 16 coupled to the housing 12 to rotate therewith. The assembly 10 further includes an inner member or hub 18 received within the housing 12 and supported to rotate relative to the sprocket 16. Still further, the assembly 10 includes a coupling pack, generally indicated at 20, received within the housing 12 and having discs 22 (i.e., friction and separator or reaction plates) spaced along the central axis 14 in first and second sets that alternate with each other and respectively have connections to the annular housing 12 and the inner member 18. The assembly 10 further includes an actuator or actuator plate 24 partially received within the housing 12 and having connections to the inner member 18 for compressing the coupling pack 20 to rotationally couple the annular housing 12 and the inner member 18 to each other about the central axis 14. The assembly 10 also includes a pair of belleville springs 26 received within a spring pocket 28 formed within the inner member 18. The springs 26 are received within the pocket 28 between the actuator plate 24 and the inner member 18 for decompressing the coupling pack 20 to rotationally decouple the annular housing 12 and the inner member 18 from each other about the central axis 14.

Other prior art related to the present invention includes the following U.S. patent documents: U.S. Pat. Nos. 7,150,347; 5,416,966; 2007/0084694; 2005/0263366 and 2005/0067250.

### SUMMARY OF THE INVENTION

An object of the present invention is to provide an improved coupling assembly.

In carrying out the above object and other objects of the present invention, a coupling assembly including an annular housing having a central axis, an inner member received within the housing and a plurality of coupling components received within the housing are provided. The components include a coupling pack having discs spaced along the central axis in first and second sets that alternate with each other and respectively have connections to the annular housing and the inner member. The components also include an actuator having connections to the inner member for compressing the coupling pack to rotationally couple the annular housing and the inner member to each other about the central axis. The assembly further includes a set of retainers received within the housing and which are spaced angularly about the central axis and have outer ends supported by the housing. The retainers have inner ends that are located toward the central axis from their outer ends. The retainers hold the coupling components within the housing.

The components may further include at least one spring between the actuator and the inner member for decompressing the coupling pack to rotationally decouple the annular housing and the inner member from each other about the central axis.

The inner member may include a first portion and an annular second portion extending axially from the first portion wherein the retainers hold the inner member within the housing.

Each of the retainers may include a retaining tab wherein the outer ends of the retaining tabs are integrally formed with the housing at an inner surface of the housing.

The annular housing may have an opening through which the coupling components are received within the housing wherein the inner ends of the retainers are positioned within the opening to engage an outer axial face of the actuator to hold the coupling components within the housing.

The retainers may be bendable so that the inner ends of the retainers have a plurality of retaining positions within the opening.

The actuator may comprise an actuator ring having an inner axial face that engages the coupling pack and the at least one spring.

The assembly may include a spring pack which engages the inner axial face of the actuator ring.

Further in carrying out the above object and other object of the present invention, a coupling assembly including an annular housing having a central axis, an inner member received within the housing and a plurality of coupling components received within the housing is provided. The components include a coupling pack having discs spaced along the central axis in first and second sets that alternate with each other and respectively have connections to the annular housing and the inner member. The components also include an actuator having connections to the inner member for compressing the coupling pack to rotationally couple the annular housing and the inner member to each other about the central axis. The assembly also includes a set of retaining tabs received within the housing and which are spaced angularly about the central axis. The tabs have outer ends integrally formed with the housing at inwardly facing splines of the housing. The retaining tabs also have inner ends that are located toward the central axis from their outer ends. The retainers hold the coupling components within the housing.

The components may further include at least one spring between the actuator and the inner member for decompressing the coupling pack to rotationally decouple the annular housing and the inner member from each other about the central axis.

The inner member may include a first portion and an annular second portion extending axially from the first portion wherein the retaining tabs hold the inner member within the housing.

The annular housing may have an opening through which the coupling components are received within the housing wherein the inner ends of the retaining tabs are positioned within the opening to engage an outer axial face of the actuator to hold the coupling components within the housing.

The objects, features and advantages of the present invention are readily apparent from the following detailed description of the preferred embodiment when taken in connection with the accompanying drawings.

### BRIEF DESCRIPTION OF THE DRAWINGS

FIG. 1 is a view, partially broken away and in cross section, of a prior art coupling assembly;

FIG. 2a is an exploded perspective view of a coupling assembly constructed in accordance with at least one embodiment of the present invention;

FIG. 2b is a top plan view of an alternative reaction plate that may be used instead of the reaction plates of FIG. 2a;

FIG. 3 is a top plan view of the assembly of FIG. 2a;

FIG. 4 is a sectional view taken along lines 4-4 of FIG. 3;

FIG. 5 is a sectional view taken along lines 5-5 of FIG. 3;

FIG. 6 is a sectional view, partially broken away, taken along lines 6-6 of FIG. 3 and illustrating a retaining tab;

FIG. 7 is a side elevational view of an annular housing or drum of the assembly of FIG. 3;

FIG. 8 is a view, partially broken away, of a portion of the annular housing and a retaining tab; and

FIG. 9 is a view, partially broken away, of a portion of the annular housing including a retaining tab having various possible retaining positions.

### DETAILED DESCRIPTION OF THE PREFERRED EMBODIMENT(S)

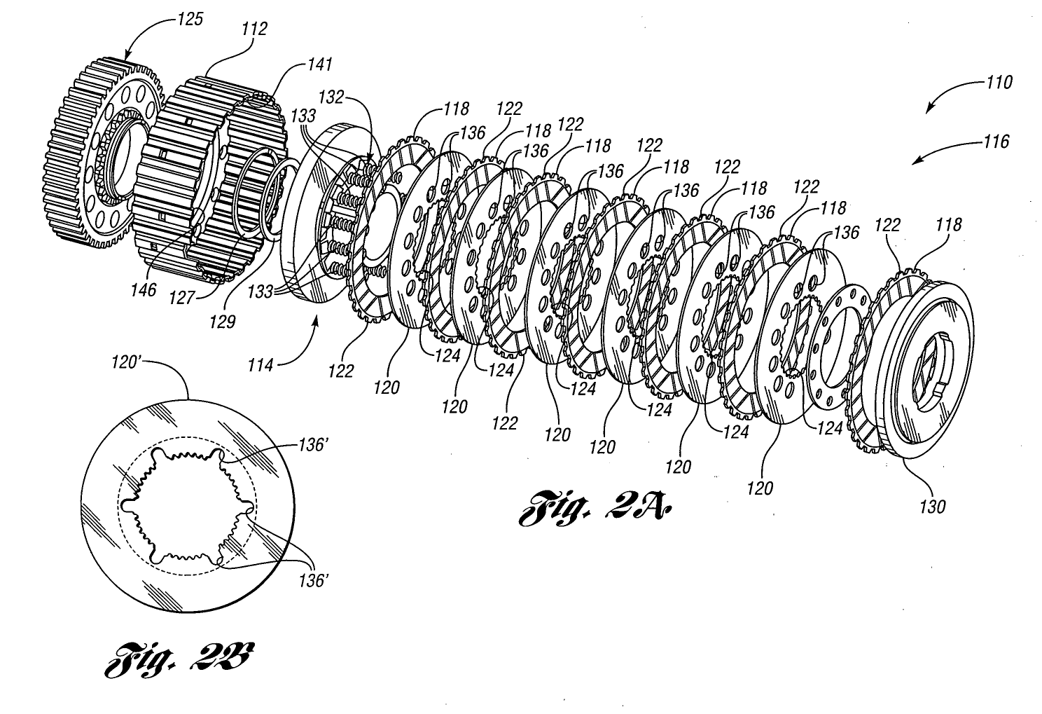

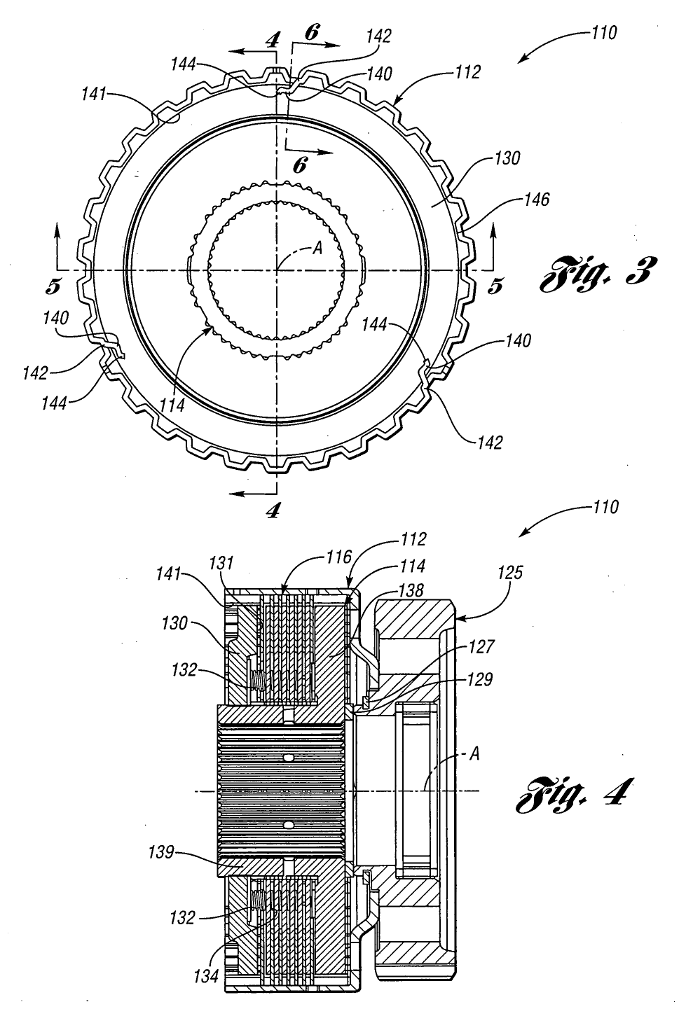

With reference to FIGS. 2a-5 of the drawings, a coupling assembly constructed in accordance with at least one embodiment of the invention is generally indicated by 110 and includes a drum or annular housing 112 having a central axis A. An inner member or hub 114 of the coupling assembly 110 is received within the housing 112 in its assembled condition.

A set of coupling components including a coupling pack 116 of the coupling assembly 110 is also received within the annular housing 112. The pack 116 includes annular discs 118 and 120 (friction plates and reaction or separator plates, respectively) spaced along the central axis A in first and second sets that alternate with each other and have respective connections 122, 124 to the annular housing 112 and the inner member 114, respectively, as is hereinafter more fully described.

The assembly 110 includes a sprocket 125 which is coupled to the housing 112 by an external snap ring 127 to rotate therewith. A bushing 129 of the assembly 110 supports the sprocket 125 on the hub 114 to rotate relative thereto.

With continuing reference to. FIGS. 2a-5 and additional reference to FIG. 6, the coupling components of the coupling assembly 110 also include an actuator or actuator ring 130 which functions to compress the clutch pack 116 at its first axial face 131 in order to rotationally couple the annular housing 112 and the inner member 114 to each other about the central axis A. The actuator 130 has an annular shape spaced about the central axis A.

Coupling components of the assembly 110 also includes a conventional spring pack 132 having a plurality of circumferentially spaced compression springs 133 disposed between two stamped plates at opposite ends of spring pack 132. Each spring 133 is received and retained with its respective chamber 134 formed by inner surfaces 136 of the reaction plates 120 when assembled and aligned between the first axial face 131 of the actuator 130 and a portion 138 of the hub 114. The springs 133 of the spring pack 130 decompress the coupling pack 116 to rotationally decouple the annular housing 112 and the inner member 114 from each other about the central axis A.

With reference to FIG. 2b, there is illustrated an alternative reaction plate 120′ which may be used instead of the reaction plate 120 in the coupling pack 116. Instead of inner surfaces 136, the reaction plate 120′ includes circular inner surfaces 136′ which are cut-outs that extend to the inner spline of the reaction plate 120′. The cut-outs form spring chambers which receive and retain the springs 133. This configuration simplifies the assembly of the friction plates 122 and the reaction plates 120′ around the spring pack 132.

Post, pocket or a combination of post and pocket features can be added to the hub 114 and/or actuator 130 inner surfaces to eliminate the need for the stamped plates of the spring pack 132. The post and pocket features would retain the springs 133 within their respective chambers 134, removing the need for the two stamped plates at the ends of the conventional spring pack 132.

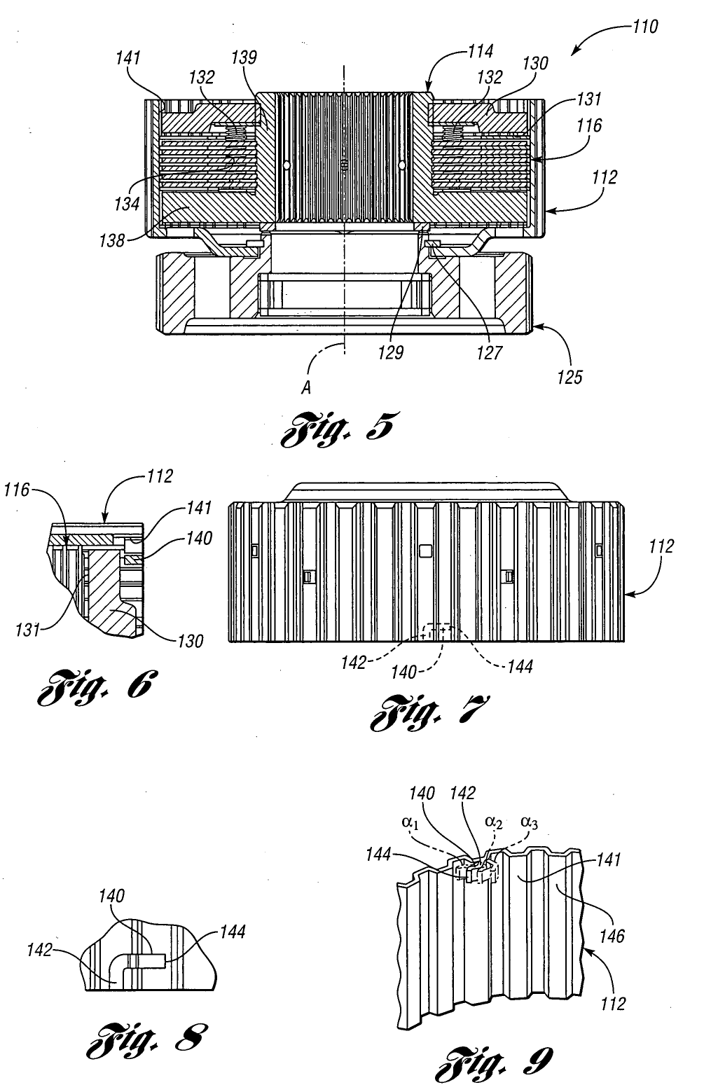

With reference to FIG. 3 and FIGS. 6-9, the assembly 110 also includes a set of retainers in the form of three bendable retaining tabs 140 which are spaced angularly about the central axis A. The retaining tabs 140 hold or retain the coupling components including the spring pack 132, the actuator 130 and the coupling pack 116 within the housing 112 after the coupling components are received through an opening 141 in the housing 112. Furthermore, the tabs 140 hold the hub 114 within the housing 112. The tabs 140 have outer ends 142 that are integrally formed with the housing 112 at an inner surface of the housing 112. The tabs 140 also have inner ends 144 that are located toward the central axis A from their outer ends 142.

As shown in FIGS. 2a, 3, and 4, the annular housing 112 has inwardly facing splines 146 for coupling with one set of the discs 118. An annular portion 139 of the hub 114 has outwardly facing splines for coupling with not only the second set of the discs 120 (or discs 120′) but also with the actuator 130.

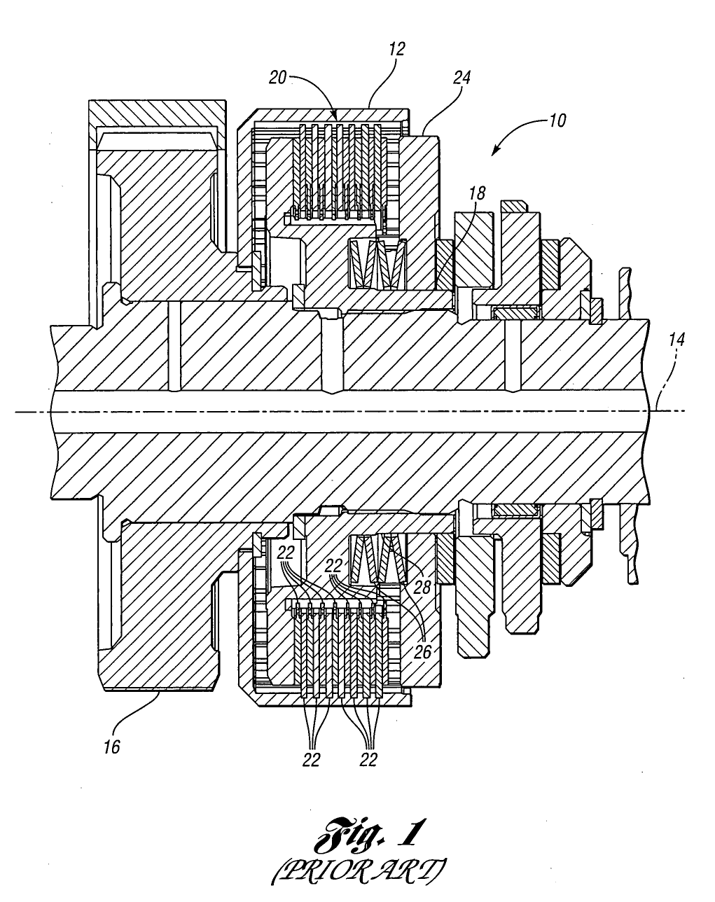

The advantages accruing to at least one embodiment of the present invention are numerous. For example, placing the springs 133 through the plates or discs 120 (or discs 120′) allows the hub and actuator plate design to be greatly simplified compared to the prior art of FIG. 1. Also, the hub 114 does not need the hub pocket 28 as shown in FIG. 1. Also, the actuator plate 130 can share common splines on the hub 114 with the other discs 120 (or discs 120′). Also, the design allows greater flexibility in spring load when compared with the prior art of FIG. 1.

As another example, the preferred retaining tabs 140 provide a simple and low cost way of holding the coupling components together and provide tamper resistance and evidence of tampering when compared to the retainer rings of the prior art.

While the preferred embodiment for carrying out the invention has been described in detail, those familiar with the art to which this invention relates will recognize alternative designs and embodiments for practicing the invention as defined by the following claims.

What is claimed is:

1. A coupling assembly comprising:
an annular housing having a central axis;
an inner member received within the housing;
a plurality of coupling components received within the housing, the components including:
a coupling pack having discs spaced along the central axis in first and second sets that alternate with each other and respectively have connections to the annular housing and the inner member; and
an actuator having connections to the inner member for compressing the coupling pack to rotationally couple the annular housing and the inner member to each other about the central axis; and
a set of retainers received within the housing and which are spaced angularly about the central axis and having outer ends supported by the housing, the retainers having inner ends that are located toward the central axis from their outer ends, the retainers holding the coupling components within the housing.

2. The assembly as claimed in claim 1 further comprising at least one spring between the actuator and the inner member for decompressing the coupling pack to rotationally decouple the annular housing and the inner member from each other about the central axis.

3. The assembly as claimed in claim 1, wherein the inner member includes a first portion and an annular second portion extending axially from the first portion and wherein the retainers hold the inner member within the housing.

4. The assembly as claimed in claim 1, wherein each of the retainers comprises a retaining tab and wherein the outer ends of the retaining tabs are integrally formed with the housing at an inner surface of the housing.

5. The assembly as claimed in claim 1, wherein the annular housing has an opening through which the coupling components are received within the housing and wherein the inner ends of the retainers are positioned within the opening to engage an outer axial face of the actuator to hold the coupling components within the housing.

6. The assembly as claimed in claim 5, wherein the retainers are bendable so that the inner ends of the retainers have a plurality of retaining positions within the opening.

7. The assembly as claimed in claim 2, wherein the actuator comprises an actuator ring having an inner axial face that engages the coupling pack and the at least one spring.

8. The assembly as claimed in claim 2, wherein a plurality of springs are located between the actuator and the inner member for decompressing the coupling pack.

9. A coupling assembly comprising:
an annular housing having a central axis;
an inner member received within the housing;
a plurality of coupling components received within the housing, the components including:
a coupling pack having discs spaced along the central axis in first and second sets that alternate with each other and respectively have connections to the annular housing and the inner member; and
an actuator having connections to the inner member for compressing the coupling pack to rotationally couple the annular housing and the inner member to each other about the central axis; and
a set of retaining tabs received within the housing and which are spaced angularly about the central axis and having outer ends integrally formed with the housing at inwardly facing splines of the housing, the retaining tabs having inner ends that are located toward the central axis from their outer ends, the retainers holding the coupling components within the housing.

10. The assembly as claimed in claim 9 further comprising at least one spring between the actuator and the inner member for decompressing the coupling pack to rotationally decouple the annular housing and the inner member from each other about the central axis.

11. The assembly as claimed in claim 9, wherein the inner member includes a first portion and an annular second portion extending axially from the first portion and wherein the retaining tabs hold the inner member within the housing.

12. The assembly as claimed in claim 9, wherein the annular housing has an opening through which the coupling components are received within the housing and wherein the inner ends of the retaining tabs are positioned within the opening to engage an outer axial face of the actuator to hold the coupling components within the housing.

13. The assembly as claimed in claim 12, wherein the retaining tabs are bendable so that the inner ends of the retaining tabs have a plurality of retaining positions within the opening.

14. A coupling assembly comprising:
an annular housing having a central axis;
an inner member including a first portion and an annular second portion extending axially from the first portion and received within the housing;
a plurality of coupling components received within the housing, the components including:
a coupling pack having discs spaced along the central axis in first and second sets that alternate with each other and respectively have connections to the annular housing and the annular second portion of the inner member; and
an actuator ring having connections to the annular second portion of the inner member and having an inner axial face that engages the coupling pack for compressing the coupling pack to rotationally couple the annular housing and the inner member to each other about the central axis; and
a set of retainers received within the housing and which are spaced angularly about the central axis and having outer ends supported by the housing, the retainers having inner ends that are located toward the central axis from their outer ends, the retainers holding the coupling components and the inner member within the housing.

15. The assembly as claimed in claim 14 further comprising a spring pack between the actuator ring and the inner member, the spring pack engaging the inner axial face of the actuator ring for decompressing the coupling pack to rotationally decouple the annular housing and the inner member from each other about the central axis;

16. The assembly as claimed in claim 14, wherein each of the retainers comprises a retaining tab and wherein the outer ends of the retaining tabs are integrally formed with the housing at an inner surface of the housing.

17. The assembly as claimed in claim 14, wherein the annular housing has an opening through which the coupling components are received within the housing and wherein the inner ends of the retainers are positioned within the opening to engage an outer axial face of the actuator to hold the coupling components and the inner member within the housing.

18. The assembly as claimed in claim 17, wherein the retainers are bendable so that the inner ends of the retainers have a plurality of retaining positions within the opening.
